(19) United States
(12) Patent Application Publication
(10) Pub. No.: US 2014/0304338 A1
(43) Pub. Date: Oct. 9, 2014

(54) APPARATUS AND METHOD FOR SHARING COLLABORATIVE STORYBOARD USING SOCIAL GROUP

(71) Applicant: Electronics and Telecommunications Research Institute, Daejeon (KR)

(72) Inventors: Hoon-Ki LEE, Daejeon (KR); Jong-Hoon LEE, Daejeon (KR); Jung-Tae KIM, Daejeon (KR); Jong-Youl PARK, Daejeon (KR)

(73) Assignee: Electronics and Telecommunications Research Institute, Daejeon (KR)

(21) Appl. No.: 14/223,776

(22) Filed: Mar. 24, 2014

(30) Foreign Application Priority Data
Apr. 8, 2013 (KR) 10-2013-0037941

(51) Int. Cl. H04L 29/08

(52) U.S. Cl. CPC H04L 67/22
USPC 709/205

(57) ABSTRACT

Disclosed herein is an apparatus and method that process knowledge, experience information, or the like possessed by group members via a dynamically created social group, in the form of collaborative storyboards, thus enabling the collaborative storyboards to be shared among a plurality of social groups, as well as the corresponding members. The presented apparatus includes a social group management unit for managing information about a social group and a user joining the social group as a member, and an information management unit for accepting information finally determined with respect to information of content desired to be shared, which is posted by the user on a storyboard of the social group, in collaboration with other users, as a post of the storyboard of the social group, and distributing the post to the social group.

### CROSS REFERENCE TO RELATED APPLICATION

This application claims the benefit of Korean Patent Application No. 10-2013-0037941 filed on Apr. 8, 2013, which is hereby incorporated by reference in its entirety into this application.

### BACKGROUND OF THE INVENTION

1. Technical Field

The present invention relates generally to an apparatus and method for sharing a collaborative storyboard using a social group and, more particularly, to an apparatus and method that allow social content possessed by members belonging to a social group dynamically created in a Social Network Service (SNS) to be shared based on the social group, thus allowing collaborative storyboards (magazines) suitable for the social group to be shared.

2. Description of the Related Art

In order to share various types of social media content (images, videos, documents, etc.) possessed by normal users, individual-centered information created by each user has been provided via personal blogs or storyboards.

Further, such social media content has been shared using methods of storing corresponding content from various types of information (for example, blogs, videos or news) shared over the Internet, configuring personal storyboards from the stored content, and providing the storyboards.

Recent SNSs are configured to form a community between users having similar areas of interest and create social groups for sharing information between the users in the community.

Most social groups (communities) are configured such that content provided by members participating in the corresponding social group is simply shared, and participation, such as comments or recommendation for the content, is provided.

Therefore, there is required an environment in which a series of procedures for processing and reproducing collected information via collaboration, rather than an object of simply sharing information, is considered to be important, and in which simple information possessed by users can be reproduced as more significant information.

Technology related to this includes the invention disclosed in Korean Patent Application Publication No. 2011-0012542 (entitled “Customized media content production system associated with digital storyboards”).

The invention disclosed in Korean Patent Application Publication No. 2011-0012542 is configured to allow a user to create his or her own scenario using a storyboard system based on sources provided by a homepage, thus assisting the user in custom-making customized media content, in which the user's opinion is sufficiently reflected, at low cost.

The invention disclosed in Korean Patent Application Publication No. 2011-0012542 includes a storyboard editor in which a storyboard production unit, a storyboard analysis unit, a script (scenario) creation unit, and an image file output unit are associated with each other; a storyboard creation unit for creating storyboard data using a scene selected by the user from a template and script input for the scene; and a database (DB) for storing the scene data and the script so that they are associated with each other.

The invention described in Korean Patent Application Publication No. 2011-0012542 is characterized in that various types of media content, such as the user's own images, albums, and videos having a story, can be produced, and in that the user can create his or her own scenario and easily produce content using a production tool provided by a storyboard system.

However, the invention described in Korean Patent Application Publication No. 2011-0012542 does not consider a configuration for allowing information to be more easily shared by constructing storyboards in collaboration with members through a social group and by allowing social groups, which do not share information, to share information.

### SUMMARY OF THE INVENTION

Accordingly, the present invention has been made keeping in mind the above problems occurring in the prior art, and an object of the present invention is to provide an apparatus and method that process knowledge, experience information, or the like possessed by group members via a dynamically created social group, in the form of collaborative storyboards, thus enabling the collaborative storyboards to be shared among a plurality of social groups, as well as the corresponding members.

In detail, the representation of information possessed by each individual has been provided and shared via blogs or personal homepages, but dynamically created social groups are communities created depending on various purposes, and thus there is a need to process and share information in conformity with the creation purpose of social groups, rather than simply sharing information.

Another object of the present invention is to provide an apparatus and method that are configured in consideration of a fact that personal information has various meanings depending on members constituting a social group, thus realizing the assignment of such meanings via the members constituting the social group.

In accordance with an aspect of the present invention to accomplish the above objects, there is provided an apparatus for sharing a collaborative storyboard using a social group, including a social group management unit for managing information about a social group and a user joining the social group as a member; and an information management unit for accepting information finally determined with respect to information of content desired to be shared, which is posted by the user on a storyboard of the social group, in collaboration with other users, as a post of the storyboard of the social group, and distributing the post to the social group.

Preferably, the information management unit may include a content management unit for managing information of content associated with the social group; and a content reconfiguration detection unit for tracking information of the content shared by the user, and reconfiguring content of other social groups so that, as the information of content shared among the social groups is changed by any one social group, other social groups are capable of viewing the changed information.

Preferably, the content management unit may be configured to maintain information of content of a social group even if the corresponding social group becomes extinct.

Preferably, the content management unit may be configured to, when a newly created social group has information similar to that of content of the extinct social group, provide the information of the content of the extinct social group to the user.

Preferably, the information management unit may further include a template management unit for providing a template when the user desires to share information on the storyboard via the social group.

Preferably, the social group management unit may include a group management unit for managing information about the social group; and a member management unit for managing information about users joining the social group as members.

Preferably, the member management unit may set a range of provision of the shared content to different ranges for respective users.

Preferably, the social group management unit further comprises a group life cycle management unit for managing a life cycle of the social group.

Preferably, the social group management unit may further include a location information management unit for searching for social groups created in surroundings based on a location of the user.

In accordance with another aspect of the present invention to accomplish the above objects, there is provided a method of sharing a collaborative storyboard using a social group, including managing, by a social group management unit, information about a user joining a social group as a member; managing, by an information management unit, information of content desired to be shared as the user uploads the content onto a storyboard of the social group; and accepting, by the information management unit, information finally determined with respect to the information of the uploaded content in collaboration with other users, as a post of the storyboard of the social group, and distributing the post to the social group.

Preferably, the information about the user may be information about a user who joins a desired social group as a member by searching social groups based on the location.

Preferably, managing the information of the content may include providing a template for the content to the user; and as the content desired to be shared is uploaded onto the template, posting the uploaded content on the storyboard of the social group.

Preferably, the method may further include setting, by the social group management unit, a range of access to the content when a user who does not join the social group desires to only share the content.

Preferably, setting the range of access to the content may be configured to set the range of access to enable only reading of the information of the content.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a service for an apparatus and method for sharing a collaborative storyboard using a social group according to an embodiment of the present invention;

FIG. 2 is a configuration diagram showing a system for the apparatus and method for sharing the collaborative storyboard using the social group according to an embodiment of the present invention;

FIG. 3 is a diagram showing the configuration of a social group management unit shown in FIG. 2;

FIG. 4 is a diagram showing the configuration of an information management unit shown in FIG. 2;

FIG. 5 is a flowchart showing a procedure for creating storyboards and sharing information through a social group in the method of sharing a collaborative storyboard using a social group according to an embodiment of the present invention;

FIG. 6 is a flowchart showing a procedure for sharing a storyboard retrieved via searching in the method of sharing a collaborative storyboard using a social group according to an embodiment of the present invention; and

FIG. 7 is a flowchart showing a method of sharing a storyboard between social groups in the method for sharing a collaborative storyboard using a social group according to an embodiment of the present invention.

FIG. 8 is an embodiment of the present invention implemented in a computer system.

### DESCRIPTION OF THE PREFERRED EMBODIMENTS

Hereinafter, an apparatus and method for sharing a collaborative storyboard using a social group according to embodiments of the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

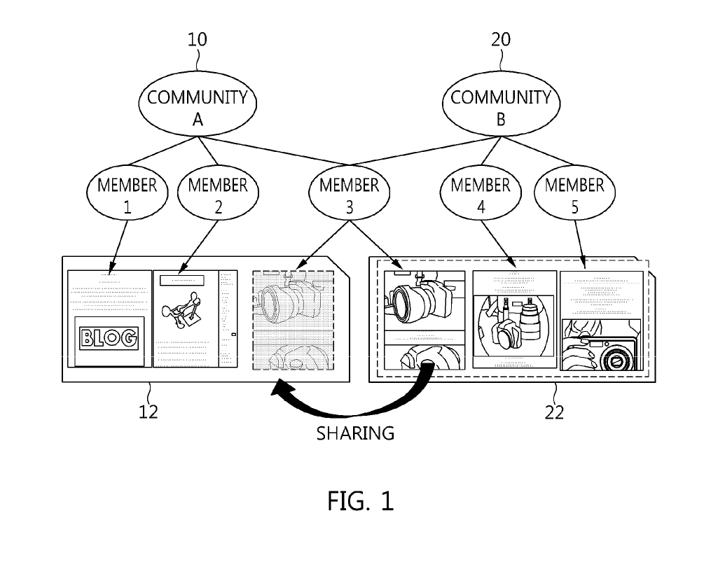

FIG. 1 is a configuration diagram showing a service for an apparatus and method for sharing a collaborative storyboard using a social group according to an embodiment of the present invention.

In the service configuration diagram of FIG. 1, storyboards created by a plurality of members belonging to different communities (that is, social groups) are configured by sharing various types of information possessed by respective persons.

Each piece of shared information may be any of various types of social media content, such as multimedia content, text documents, and blogs. Such social media content is created in storyboards provided by communities, and the created information is configured to be revised and supplemented by a plurality of members.

An existing individual-centered storyboard is provided to allow each member to function as a curator for gradually generating information desired by a social group using various types of information possessed by each member unlike a unilateral structure for simply delivering information or news.

Storyboards provide not only templates for blogs fundamentally created by members, but also standard templates for all storyboards. By means of this, the members of the corresponding community may constitute the entire structure of the storyboard using templates suitable for each piece of content.

Each member may belong to a single social group (community), but may belong to a plurality of social groups and may be provided with various types of information. Personal experience information within the storyboard belonging to a specific group may be shared among various social groups.

Such information sharing provides a more open information transfer procedure in the concept of closed information transfer.

In FIG. 1, member 3 belongs to community B 20, as well as community A 10. Member 3 provides personal experience information on a storyboard created by community B 20 so that the personal experience information may also be shared with the community A 10. Collaborative information is added to information shared by the respective communities 10 and 20 by different members, and in this case, a structure capable of mutually searching for and supplementing revised information is provided.

In this way, information reconfigured by a single community is shared between a plurality of communities, and thus the function of more efficiently transferring information and sharing information is provided.

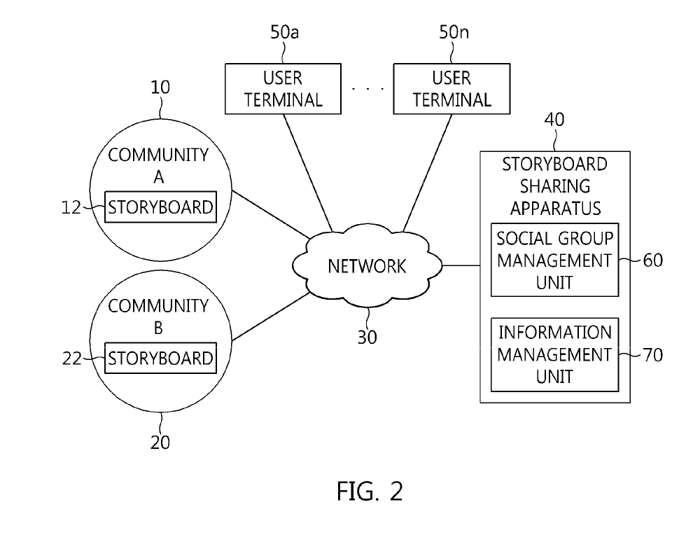

FIG. 2 is a configuration diagram showing a system for the apparatus and method for sharing a collaborative storyboard using a social group according to an embodiment of the present invention.

A plurality of communities 10 and 20 are connected to a storyboard sharing apparatus 40 over a network 30.

Further, a plurality of user terminals 50a to 50n are connected to the communities 10 and 20 and the storyboard sharing apparatus 40 over the network 30.

Each of the user terminals 50a to 50n is a device configured to perform electronic communication. For example, each of the user terminals 50a to 50n may be a mobile phone, a satellite telephone, a Personal Digital Assistant (PDA), a smart phone, a desktop computer, a lap-top computer, a tablet computer, Netbook, or the like.

The storyboard sharing apparatus 40 includes a social group management unit 60 and an information management unit 70.

The social group management unit 60 manages social groups that can be accessed by the user or each member.

The information management unit 70 manages the information of storyboards created by members.

For example, a user registered in community A 10 as a member (joined as a member) may be regarded as the member of the community A 10, and a user registered in community B 20 as a member (joined as a member) may be regarded as the member of the community B 20. Further, the term ‘user’ is a concept including a member and may be regarded as a person who accesses any social group regardless of whether the user has joined the social group.

In the specification of the present invention, a description has been made for a user and a member, separately, but the user may be limited only to a member because the operation of transferring information in the storyboard of any one social group to the storyboard of another social group may be regarded as the actual sharing of the storyboard.

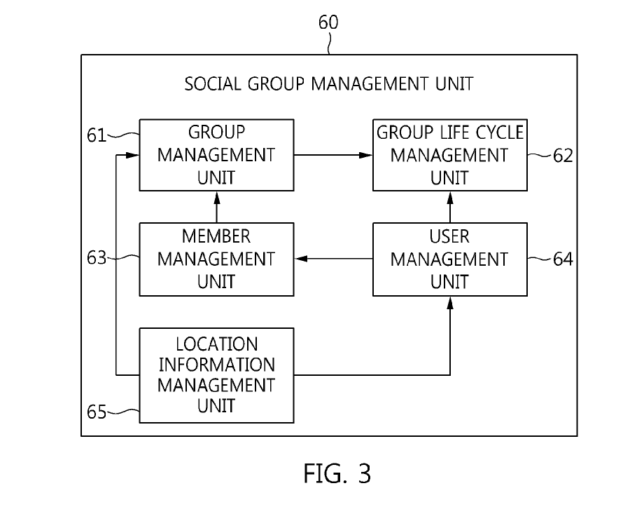

FIG. 3 is a diagram showing the configuration of the social group management unit 60 shown in FIG. 2.

The social group management unit 60 includes a group management unit 61, a group life cycle management unit 62, a member management unit 63, a user management unit 64, and a location information management unit 65.

The group management unit 61 manages a series of procedures for creating/changing/deleting social groups (communities) and also manages the profile information of the social groups (communities), via the operation and management of the social groups.

The group life cycle management unit 62 manages a life cycle ranging from the creation to the final extinction of each social group (community). Since the social group is dynamically formed based on spatial/social relationships, the group life cycle management unit 62 manages a life cycle ranging from the creation to extinction of each social group (community) under the control of the group management unit 61.

The group life cycle management unit 62 manages the life cycles of social groups formed based on various situations, such as in one-time (event), permanent, and automatic extinct characteristics, depending on the characteristics of the corresponding social group.

The member management unit 63 manages members constituting each social group. The social group allows various persons to join and leave the social group with spatial/social relationships.

Depending on the change of members, the states of various rights or control access of the respective members must be maintained. When the range of provision of shared content is limited based on a social relationship even in the case of members belonging to the same social group (community), the range of provision may be controlled by the member management unit 63, and information may be managed so that the range of provision is displayed to the user.

The user management unit 64 tracks and manages the location of the user when the location of the user is changed while basically managing the profile information of the user (e.g., gender, age, address, job, major, hobby, interest, etc.). Further, the user management unit 64 manages various types of information required to recommend a social group. The user management unit 64 transmits the profile information of the user, entered for member joining, to the member management unit 63.

In the embodiment of the present invention, although the member management unit 63 and the user management unit 64 have been configured as separate components, they may be integrated into a single module to enable the functions of both the member management unit 63 and the user management unit 64 to be performed through the single module.

The location information management unit 65 stores location-based information, such as geotagging information, according to the location of the user as well as the location-based information of each social group. Due to the movement of the user, the current location of the user may be changed. Therefore, the location information management unit 65 stores log depending on the change of individual locations and manages information enabling the feedback of related activities (social activities) so as to track various activities conducted at a specific location.

In this way, the social group management unit 60 for maintaining a required social group is configured using members constituting the social group, various types of profile information of the members, and the location information of each user and the social group (community).

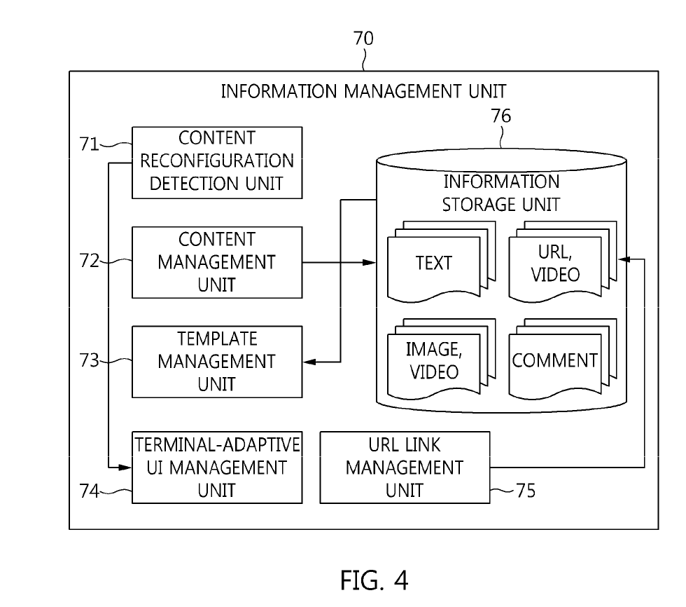

FIG. 4 is a diagram showing the configuration of the information management unit 70 shown in FIG. 2.

The information management unit 70 manages various types of experience and knowledge information generated by a user (including a member) who uses a social group (community). The information management unit 70 includes a content reconfiguration detection unit 71, a content management unit 72, a template management unit 73, a terminal-adaptive User Interface (UI) management unit 74, a Uniform Resource Locator (URL) link management unit 75, and an information storage unit 76.

The content management unit 72 manages the information of content related to each member of a social group and the corresponding social group. The content management unit 72 connects content associated with each social group and configures recommended information. Accordingly, the content management unit 72 continuously maintains the content information of an extinct social group even if a social group becomes extinct, and is capable of providing the content information of the extinct social group to the user if a new social group that is created subsequently has content information similar to that of the extinct social group.

Further, the information shared by the user is tracked by the content reconfiguration detection unit 71. Posted information is held and reconfigured by various social groups. In this case, when the same content is shared among a plurality of social groups, if the information of the content is changed by a specific social group, the content reconfiguration detection unit 71 reconfigures the content of a related group so that other social groups which share the content may view the updated details of the changed information.

When the user shares personal information, knowledge, etc. on a storyboard via the social group, the user must be provided with various templates depending on the types of pieces of content. The template management unit 73 provides various templates depending on the information types, such as multimedia information, text documents, and blogs, thus enabling storyboards to be more easily created.

The users belonging to a social group have various types of terminals. The terminal-adaptive UI management unit 74 adaptively provides UI parts that are provided to the users depending on the operating systems or the specifications of the terminals. The screen sizes, operating systems, and user interfaces of the terminals are used to analyze the terminals at time at which the users access the social group, and to configure a screen required to provide optimal information via the results of the analysis.

The URL link management unit 75 may provide information accessible on the Internet among pieces of knowledge and experience information provided by each user. With regard to the information posted via the URL of the corresponding information, if a predetermined time has elapsed or if an information publisher does not post information any longer, the URL link management unit 75 manages the link information of the corresponding URL. In the case of information having no link, the URL link management unit 75 deletes the information or notifies the user of the change of the information.

The information storage unit 76 is configured to, when the storage of server-centered information is desired and when the storage of only the storage location of information is desired in a method of allowing each individual to post content, manage such storage. The information storage unit 76 manages the actual information of the corresponding content, such as text, images, videos, and comments, and maintains information about the characteristics of the content and various tags of the content. Further, the information storage unit 76 stores Uniform Resource Locator (URL) information, which is used when the actual location of content is different, that is, when the content is stored in a place other than the apparatus of the present invention.

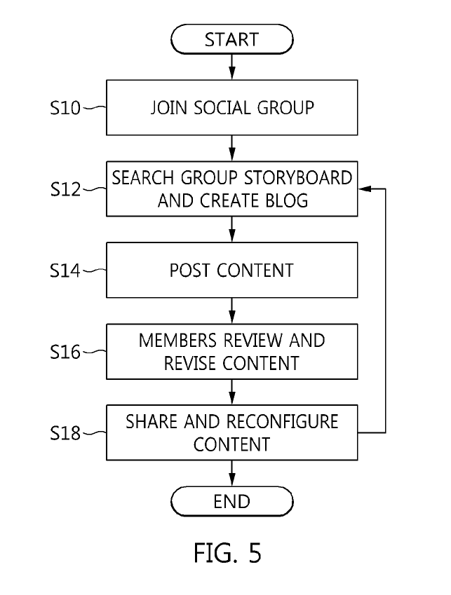

FIG. 5 is a flowchart showing a procedure for creating storyboards and sharing information through a social group in the method of sharing a collaborative storyboard using the social group according to an embodiment of the present invention.

A user searches surrounding social groups for a desired social group via a service and joins the desired social group at step S10. Information required to join the desired social group is entered via a user terminal. Since the user has joined the social group, the user becomes the member of the corresponding social group. The profile information of the member is managed by the member management unit 63 via the user management unit 64 of the social group management unit 60.

Then, the user searches for the storyboard of the content provision group provided by the joined social group, and creates a blog using a template provided by the service so as to share the content of the user at step S12. In this case, the user may create the blog using the template provided by the template management unit 73 of the information management unit 70.

Further, the user uploads content desired to be shared onto the template of the blog via the user terminal and posts the content on the storyboard of the corresponding social group at step S14. The content posted in this way is managed by the content management unit 72 of the information management unit 70 and is tracked by the content reconfiguration detection unit 71.

Then, the content reconfiguration detection unit 71 provides the posted content through the terminal-adaptive UI management unit 74 so that the content may be reviewed by a plurality of members of the social group. Further, the members revise information required for posts shared with each other in collaboration with each other at step S16. This is not intended to simply post all information via the storyboard of the social group and is intended to induce the members to share more reliable information by allowing the members to review the posted information via opinions of various members constituting the social group and the verification of the actually posted information. Such a collaboration procedure may eliminate various errors occurring in the simple provision of information.

The information revised via collaboration is accepted as the post of the storyboard of the corresponding community (social group) via the final discussion of the members and is formally distributed to the entire social group. That is, the information management unit 70 accepts information finally determined with respect to the information of content desired to be shared, which is initially posted by the user on the storyboard of the social group, in collaboration with other users, as the post of the storyboard of the corresponding social group, and distributes the post to the members of the social group so that the members can view the post.

On the storyboard of the social group, the reconfiguration of the content and the reconfiguration of a screen UI are performed according to the distributed information at step S18. Here, the reconfiguration of the content is performed by the content reconfiguration detection unit 71, and the reconfiguration of the screen UI is performed by the terminal-adaptive UI management unit 74.

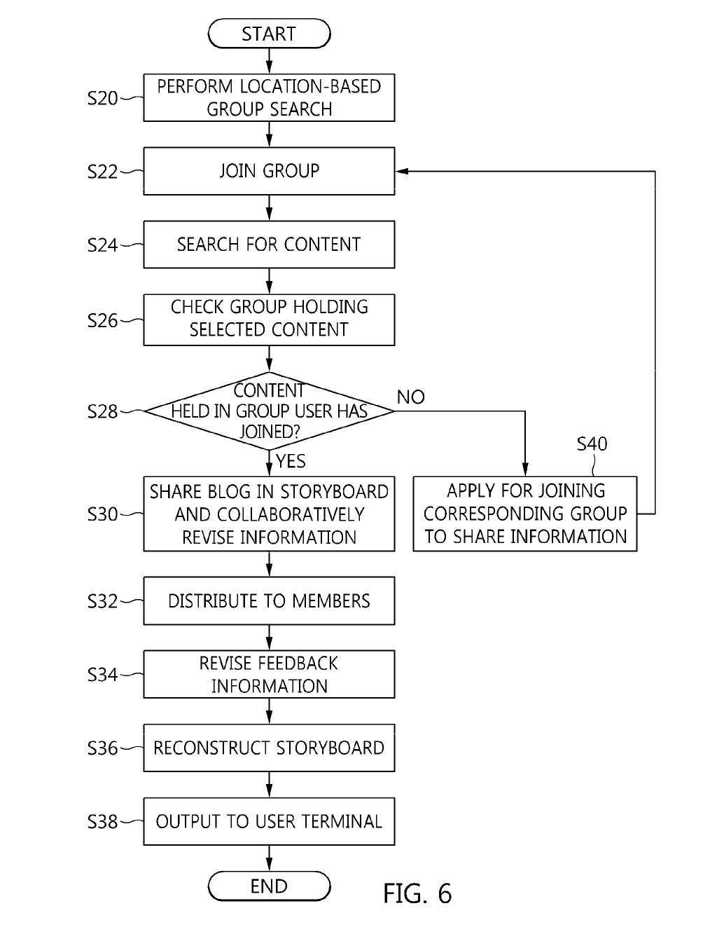

FIG. 6 is a flowchart showing a procedure for sharing a storyboard retrieved via searching in the method of sharing a collaborative storyboard using a social group according to an embodiment of the present invention. Information shared by most social groups is limited to social groups which the user has joined. FIG. 6 is a flowchart showing a procedure in which a user searches for information of content provided by a social group which the user does not join, and then joins the group which holds the corresponding content so as to share the content, thus sharing the content.

The user searches a plurality of social groups which are created in surroundings, based on his or her location at step S20. That is, the user performs a location-based group search via his or her terminal (user terminal). In this case, upon searching for a group based on location, the user management unit 64 of the social group management unit 60 recommends a social group close to the location of the user to the user, thus allowing the user to easily search for a group based on the location.

As the location-based search for a social group has been completed, the user applies for joining the social group, the information of which is desired to be shared, if the user has not joined the social group at step S22. The user applies for joining through his or her terminal (user terminal). Further, the profile information of the user based on the joining of the user is managed by the user management unit 64, and the member management unit 63 sets the right or control access of the corresponding member (since the user has joined the social group, the user becomes the member of the social group) based on the information received from the user management unit 64.

Then, the user searches for information using a keyword or searches a recommended storyboard (that is, the storyboard of the recommended social group) for information in order to search for information shared through the social group at step S24. Information (content) search may be performed to search not only the social group the user has joined, but also social groups the user has not joined for various types of content held by the social groups. This is possible because the content management unit 72 of the information management unit 70 may manage and provide the information of content related to individual social groups.

The user checks a social group which holds content selected from among pieces of found (retrieved) shared content at step S26.

Then, it is determined whether the social group the user has joined holds the corresponding shared content at step S28.

If it is determined that the social group the user has joined holds the shared content (in the case of “Yes” at step S28), the user may share a blog in the storyboard, and may collaboratively revise the corresponding information if necessary at step S30. Here, the information changed by collaborative revision is stored in the information storage unit 76 via the content management unit 72 of the information management unit 70.

Thereafter, the information management unit 70 distributes the information of the corresponding content, changed via the sharing and revision of the shared information, to the corresponding social group and a plurality of members which are permitted to share the content at step S32.

Then, the plurality of members discuss the changed information of the content with each other. As details discussed by the individual members are fed back into all of the members participating in the discussion, the revision of information is completed at step S34. In this case, the discussed details are stored in the information storage unit 76 via the content management unit 72 of the information management unit 70.

Using each piece of content retrieved, shared, and reproduced in this way, the storyboard is reconstructed at step S36. Here, the reconstruction of the storyboard is performed by the template management unit 73.

Further, since the reconstructed storyboard is output to the user terminal via the terminal-adaptive UI management unit 74, users may share the reconstructed storyboard at step S38.

In contrast, if it is determined at step S28 that the social group the user has joined does not hold the shared content, the user applies for joining a social group which holds the shared content so as to share the content at step S40. Accordingly, the procedure including the above-described steps S22 to S38 may be performed.

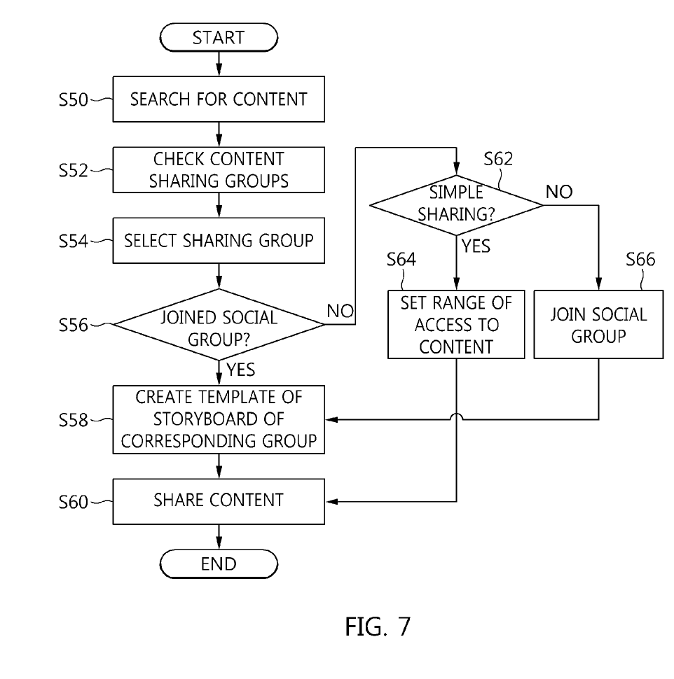

FIG. 7 is a flowchart showing a method of sharing a storyboard between social groups in the method for sharing a collaborative storyboard using a social group according to an embodiment of the present invention.

The embodiment of the present invention enables a storyboard provided by a specific social group to be shared with other social groups.

The user searches a storyboard desired to be shared for content posted by the user at step S50.

Next, the user checks a list of groups which share the retrieved content at step S52.

Then, the user selects a social group desired to be shared from the checked list of content sharing groups at step S54. Accordingly, a signal corresponding to the selection of the group (that is, a group selection signal) is transmitted to the social group management unit 60.

The user management unit 64 of the social group management unit 60 transfers the group selection signal to the member management unit 63, and the member management unit 63 determines whether the user is a member who has joined the corresponding social group (community) at step S56.

If it is determined that the user has already joined the social group (in the case of “Yes” at step S56), the template management unit 73 provides the template of the storyboard of the social group desired to be shared to the user. That is, it means that the template management unit 73 transmits the template to the terminal of the user.

Accordingly, the user is allocated the template of the storyboard of the social group desired to be shared, and creates the corresponding content at step S58.

As the creation of the content has been completed, the user posts the content on the storyboard of the social group desired to be newly shared and shares the content with other members at step S60. Then, after the creation of the content has been completed, the created content is stored in the information storage unit 76 via the content management unit 72 of the information management unit 70.

In contrast, if it is determined at step S56 that the user has not joined the social group desired to be shared, a sharing method is selected.

For example, when the user desires only to share content without joining the social group (that is, the social group desired to be shared) (in the case of “Yes” at step S62), that is, when the user selects simple sharing, the member management unit 63 of the social group management unit 60 sets the range of access to the corresponding content (also referred to as “range of provision”). The range of access may be set using various access methods depending on whether to allow content to be shared among all members of the social group and depending on a social relationship or a spatial relationship with the user at step S64.

The content, for which only the range of access is set, is not shared via the template of the storyboard of the corresponding social group, and is shared only for reading.

If the user has not joined the social group and desires to join the social group, the user joins the social group at step S66. Accordingly, the information, entered when the user joins the group, is transferred to the member management unit 63 via the user management unit 64. The template management unit 73 of the information management unit 70 provides the template of the storyboard of the social group the user has joined to the user. Therefore, the user normally shares the storyboard in the social group based on the provided storyboard template.

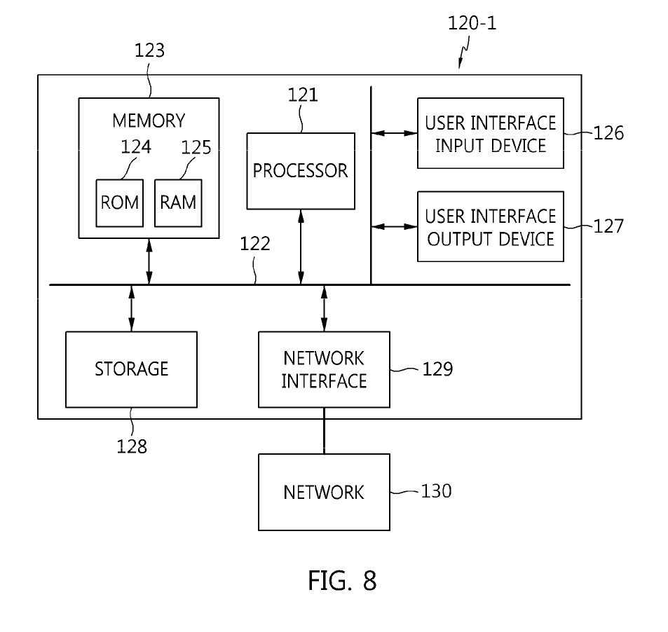

FIG. 8 is an embodiment of the present invention implemented in a computer system.

Referring to FIG. 8, an embodiment of the present invention may be implemented in a computer system, e.g., as a computer readable medium. As shown in in FIG. 8, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention having the above configuration, new information may be created by performing information processing and reconfiguration in collaboration with members in the method of forming a dynamic group and sharing various types of knowledge or experience information possessed by members constituting the group.

Further, the present invention is advantageous in that the reprocessing of information occurs based on a social group (community) to which each individual belongs, and the reprocessed information is shared in the social group, thus allowing users to easily access various types of information required by the users.

Furthermore, in the case of fluctuating information, such as that of a social group, even if the creation/extinction/change of the social group has occurs according to its life cycle, an existing collaborative storyboard that has been previously created may be shared depending on the purpose thereof.

Meanwhile, the present invention is not limited by the above embodiments, and various changes and modifications can be implemented without departing from the scope and spirit of the invention. It should be understood that the technical spirit of the changes and modifications also belongs to the scope of the accompanying claims.

What is claimed is:

1. An apparatus for sharing a collaborative storyboard using a social group, comprising:
a social group management unit for managing information about a social group and a user joining the social group as a member; and
an information management unit for accepting information finally determined with respect to information of content desired to be shared, which is posted by the user on a storyboard of the social group, in collaboration with other users, as a post of the storyboard of the social group, and distributing the post to the social group.

2. The apparatus of claim 1, wherein the information management unit comprises:
a content management unit for managing information of content associated with the social group; and
a content reconfiguration detection unit for tracking information of the content shared by the user, and reconfiguring content of other social groups so that, as the information of content shared among the social groups is changed by any one social group, other social groups are capable of viewing the changed information.

3. The apparatus of claim 2, wherein the content management unit is configured to maintain information of content of a social group even if the corresponding social group becomes extinct.

4. The apparatus of claim 3, wherein the content management unit is configured to, when a newly created social group has information similar to that of content of the extinct social group, provide the information of the content of the extinct social group to the user.

5. The apparatus of claim 2, wherein the information management unit further comprises a template management unit for providing a template when the user desires to share information on the storyboard via the social group.

6. The apparatus of claim 1, wherein the social group management unit comprises:
a group management unit for managing information about the social group; and
a member management unit for managing information about users joining the social group as members.

7. The apparatus of claim 6, wherein the member management unit sets a range of provision of the shared content to different ranges for respective users.

8. The apparatus of claim 6, wherein the social group management unit further comprises a group life cycle management unit for managing a life cycle of the social group.

9. The apparatus of claim 6, wherein the social group management unit further comprises a location information management unit for searching for social groups created in surroundings based on a location of the user.

10. A method of sharing a collaborative storyboard using a social group, comprising:
managing, by a social group management unit, information about a user joining a social group as a member;
managing, by an information management unit, information of content desired to be shared as the user uploads the content onto a storyboard of the social group; and
accepting, by the information management unit, information finally determined with respect to the information of the uploaded content in collaboration with other users, as a post of the storyboard of the social group, and distributing the post to the social group.

11. The method of claim 10, wherein the information about the user is information about a user who joins a desired social group as a member by searching social groups based on the location.

12. The method of claim 10, wherein managing the information of the content comprises:
providing a template for the content to the user; and
as the content desired to be shared is uploaded onto the template, posting the uploaded content on the storyboard of the social group.

13. The method of claim 10, further comprising, setting, by the social group management unit, a range of access to the content when a user who does not join the social group desires to only share the content.

14. The method of claim 13, wherein setting the range of access to the content is configured to set the range of access to enable only reading of the information of the content.
